(19) United States
(12) Patent Application Publication
(10) Pub. No.: US 2012/0120179 A1
(43) Pub. Date: May 17, 2012

(54) Method, system and terminal for implementing wireless video conference

(75) Inventors: Jichao Li, Shenzhen (CN); Yong Ling, Shenzhen (CN); Zhenzhuo Zeng, Shenzhen (CN)

(73) Assignee: ZTE CORPORATION, Shenzhen, Guangdong (CN)

(21) Appl. No.: 13/258,087

(22) PCT Filed: Dec. 10, 2009
(86) PCT No.: PCT/CN2009/075449

§ 371 Date: Jan. 16, 2012

(30) Foreign Application Priority Data
Jul. 16, 2009 (CN) 200910089390.3

(51) Int. Cl. H04N 7/15; H04W 4/16

(52) U.S. Cl. 348/14.02; 348/E07.083

(57) ABSTRACT

A method for implementing a wireless video conference is disclosed, comprising that: an initiator Wireless Access Terminal (AT) initiates a conference request to a Packet Core Network (PCN); and the PCN performs conference invitation according to a conference inviter list included in the received conference request, establishes a radio resource and performing initialization for each AT attending the wireless video conference, and sends the information of conference members attending the wireless video conference to the initiator AT for storing to complete the establishment of a wireless video conference system; after the wireless video conference system is established successfully, the PCN receives a signalling flow of the AT in the wireless video conference system and sends the received signalling flow to the initiator AT; and the initiator AT sends a control command to the PCN according to a signalling in the received signalling flow to control the PCN to distribute an information flow in the wireless video conference system. The disclosure also discloses a system for implementing the wireless video conference and an AT. By adopting the disclosure, a multi-party wireless video conference can be implemented.

### TECHNICAL FIELD

The disclosure relates to the technology of wireless video conference, in particular to a method, a system and a terminal for implementing a wireless video conference.

### BACKGROUND

With the rapid development of computers and wireless network technology, conventional wireless communication modes such as telephones, faxes and the like cannot meet ever-growing communication needs of today because of the incapability of achieving a face-to-face communication effect, while an ever-growing wireless network environment makes the wireless transmission of video and audio possible, and a prominent application is a remote wireless video conference.

With the wide commercialization of wireless broadband network, a high-speed data transmission link of the wireless broadband network has guaranteed the heavy traffic is information transmission, so that a wireless video function is widely applied. The structure of the wireless broadband network is shown as FIG. 1, in which data communication between a Wireless Access Terminal (AT) 11 and a Radio Access Network (RAN) 12 is performed via an air interface (UM interface). The AT 11 is provided with video and audio acquisition equipment such as a camera, a microphone and the like; the RAN 12 is connected with a Packet Core Network (PCN) 13 via an interface A; the PCN 13 is connected with an external Internet Protocol (IP) network 14 such as the Internet via a parallel interconnection interface (Pi interface) which follows the IS-835 standard.

It can be seen that the AT has the function of acquiring video and audio data, and the AT is connected to the PCN by accessing into the RAN, so as to access to a wireless broadband network system. However, in the AT and the accessed wireless broadband network system, there is a lack of the control of the information stream among multiple ATs at present, including the control of an audio and/or video stream, the control of a data stream and the like. Moreover, the prior art which only provide a two-party video call cannot provide a multi-party video call function, therefore cannot provide a multi-party wireless video conference function.

### SUMMARY

The main object of the disclosure is to provide a method, a system and a terminal for implementing a wireless video conference to realize a multi-party wireless video conference.

In order to achieve the object, the technical solution of the disclosure is provides as follows.

The disclosure provides a method for implementing the wireless video conference, comprising that:

an initiator AT initiates a conference request to a PCN; and the PCN performs conference invitation according to a conference inviter list included in the received conference request, establishes a radio resource and performs initialization for each AT which attends the wireless video conference, and sends the information of conference members attending the wireless video conference to the initiator AT for storing to complete the establishment of a wireless video conference system;

after the wireless video conference system is established successfully, the PCN receives a signalling flow of the AT in the wireless video conference system and sends the received signalling flow to the initiator AT; and the initiator AT sends a control command to the PCN according to a signalling in the received signalling flow to control the PCN to distribute an information flow in the wireless video conference system.

Preferably, the conference request comprises: a conference inviter list, the high-priority authority of the initiator AT and the authority distributed to the AT in the conference inviter list.

Preferably, the step of establishing the radio resource and performing initialization for each AT which attends the wireless video conference comprises that: after the PCN receives the conference request, authenticates and authorizes the initiator AT successfully, the PCN establishes the radio resource for the initiator AT, sends point to point protocol (PPP) initialization information to the initiator AT, and assigns an IP address to the initiator AT; when receiving a conference participation command returned by an participant AT, the PCN establishes a radio resource for the participant AT, sends the PPP initialization information to the participant AT, and assigns an IP address for the participant AT.

Preferably, the conference member information comprises: a conference member list, a high-priority authority of the initiator AT, the authority of the participant AT which attends the wireless video conference and the IP addresses of all ATs. Preferably, the step of receiving the signalling flow of the AT in the wireless video conference system by the PCN comprises that: the PCN receives the signalling flow of the participant AT and the initiator AT through a RAN, wherein the signalling flow comprises: a presentation request command, a video request command and a data sharing request command.

Preferably, the step of sending the control command to the PCN by the initiator AT according to the signalling in the received signalling flow comprises that: the initiator AT receives the signalling flow from the PCN, performs analysis processing to the signalling in the signalling flow, and sends the control command to the PCN according to the result of the analysis processing.

Preferably, the step of controlling the PCN to distribute the information flow in the wireless video conference system comprises that: the PCN receives and sends an audio and/or video flow of the AT which sends the presentation request according to a presentation permission command of the initiator AT; and/or, the PCN distributes a data flow according to the data sharing command of the initiator AT; and/or, the PCN distributes the video flow according to a video distribution command of the initiator AT; and/or, the PCN releases all UM interface radio resources according a conference ending command of the initiator AT.

The disclosure also provides a system for implementing the wireless video conference. The system comprises:

an initiator AT configured for initiating the conference request, sending and receiving the signalling flow and the information flow, performing the analysis processing to the signalling in the received signalling flow, and sending a control command to control the PCN to distribute the information flow in the wireless video conference system;

a participant AT configured for attending the wireless video conference, sending and receiving the signalling flow and the information flow, and processing the received information flow; and

a PCN configured for performing conference invitation according to the conference inviter list included in the received conference request, establishing the radio resource and performing initialization for each AT which attends the wireless video conference; simultaneously the PCN configured for receiving and sending the information flow and the information flow of each AT, and distributing the information flow according to the control command of the initiator AT.

Preferably, the system further comprises the RAN configured for transferring the signalling flow and the information flow in the system.

Preferably, the initiator AT further comprises:

a first information processing module configured for sending and receiving the signalling flow and the information flow through the RAN;

a terminal control module configured for processing the signalling flow and the information flow received through the RAN, and sending a control command for controlling the PCN to distribute the information flow through the RAN;

a first audio and video module configured for converting the audio and/or video flow, distributed by the PCN, received by the first information processing module into voice and/or video;

Preferably, the initiator AT further comprises:

a first audio and video acquisition module configured for acquiring the audio and/or video data of the initiator AT and sending the audio and/or video flow to the PCN under the calling of the first information processing module;

a first data storage module configured for sending the stored data of the initiator AT to the PCN through the RAN under the calling of the first information processing module, or storing the data flow, distributed by the PCN, received by the first information processing module.

Preferably, the participant AT further comprises:

a second information processing module configured for sending and receiving the signalling flow and the information flow through the RAN;

a second audio and video module configured for converting the audio and/or video flow, distributed by the PCN, received by the second information processing module, into voice and/or video.

Preferably, the participant AT also comprises:

a second audio and video acquisition module configured for acquiring the audio and video data of the participant AT and sending the audio and/or video flow to the PCN under the calling of the second information processing module;

a second data storage module configured for sending the stored data of the participant AT to the PCN through the RAN, or storing the data flow, distributed by the PCN, received by the second information processing module under the calling of the second information processing module.

The disclosure also provides the AT, comprising:

an information processing module configured for sending and receiving the signalling flow and the information flow;

a terminal control module configured for sending the control command for controlling the PCN to distribute the information flow and processing the received signalling flow and the information flow when the AT serves as the initiator AT;

an audio and video module configured for converting the audio and/or video flow, distributed by the PCN, received by the information processing module into the voice and/or video,

Preferably, the AT further comprises:

an audio and video acquisition module configured for acquiring the audio and/or video data of the AT and sending the audio and/or video flow to the PCN under the calling of the information processing module;

a data storage module configured for sending the stored data of the AT to the PCN through the RAN under the calling of the information processing module, or storing the data flow, distributed by the PCN, received by the information processing module.

The method, the system and the terminal for implementing the wireless video conference provided by the disclosure realize the multi-party wireless video conference by sending the signalling in the wireless video conference system to the initiator AT, generating the control command by the initiator AT according to the received signalling, sending the control command to the PCN, and distributing the information flow in the wireless video conference system by the PCN according to the control command, so that each AT in the wireless video conference system could obtain required information flow by sending the signalling.

In addition, the establishment of the overall wireless video conference system and the distribution of the information flow in the implementation process of the wireless video conference are controlled by the initiator AT, so that the multi-party wireless video conference is realized and simultaneously uniform wireless video conference control is ensured; therefore, the implementation of the wireless video conference is safer, more is reliable and more effective.

### BRIEF DESCRIPTION OF THE DRAWINGS

FIG. 1 shows a diagram of wireless broadband system network architecture;

FIG. 2 shows a flowchart of the method for implementing the wireless video conference of the disclosure;

FIG. 3 shows a structural diagram of the system for implementing the wireless video conference of the disclosure; and

FIG. 4 shows a structural diagram of an AT provided by the disclosure.

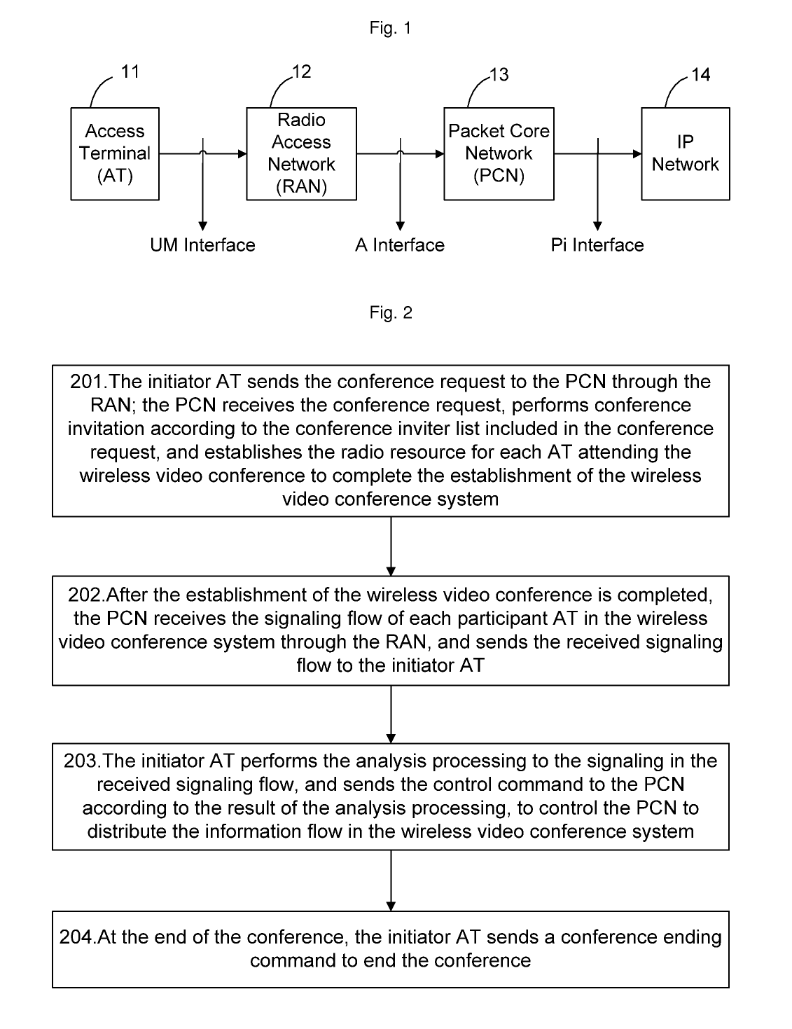

### DETAILED DESCRIPTION

The basic idea of the disclosure is that: the initiator AT serves as an information flow control party, generates the control command, and sends the control command to the PCN; and the PCN completes distributing the information flow in the wireless video conference system according to the control command.

The disclosure is detailed below in conjunction with the accompanying drawings and specific embodiments.

The method for implementing the wireless video conference of the disclosure is shown as the FIG. 2, which comprises the following steps:

Step 201: the initiator AT sends the conference request to the PCN through the RAN; the PCN receives the conference request, performs conference invitation according to the conference inviter list included in the conference request, and establishes the radio resource for each AT attending the wireless video conference to complete the establishment of the wireless video conference system;

usually, aiming at a certain wireless video conference, a certain AT among multiple ATs connected with the RAN via the UM interface can serve as the initiator AT. Step 201 is as follows specifically: the initiator AT sends the conference request to the PCN through the RAN, wherein the conference request comprises a conference inviter list, high-priority authority of the initiator AT, the authority distributed to the AT in the conference inviter list and the like; the RAN receives the conference request and is forwards the conference request to the PCN; after receiving the conference request, the PCN authenticates and authorizes the initiator AT; after a successful authentication and authorization, the PCN establishes the radio resource for the initiator AT, sends PPP initialization information to the initiator AT, and assigns an IP address to the initiator AT; simultaneously, the PCN sends the conference invitation through the RAN according to the conference inviter list in the conference request; and the AT which receives the conference invitation returns a participation or nonparticipation conference command;

when receiving the participation conference command, the PCN establishes the radio resource for the participant AT, sends the PPP initialization information and assigns the IP address; after the radio resource of all participant ATs is successfully established, the PCN sends the conference member information to the initiator AT through the RAN for storing, wherein the conference member information comprises a conference member list, the high-priority authority of the initiator AT, the authority of the participant AT, the IP addresses of all ATs and the like; and the establishment of the wireless video conference system is completed.

In the step, performing the conference invitation comprises that: the PCN sends a conference invitation message to each AT in the conference inviter list.

Step 202: after the establishment of the wireless video conference is completed, the PCN receives the signaling flow of each participant AT in the wireless video conference system through the RAN, and sends the received signaling flow to the initiator AT;

specifically, after the successful establishment of the wireless video conference system, the PCN receives the signaling flow of the participant AT and the initiator AT through the RAN, wherein the signaling flow comprises the presentation request command, the video request command, the data sharing request command and the like; and the PCN sends the received signaling flow to the initiator AT.

Step 203: the initiator AT performs the analysis processing to the signaling in the received signaling flow, and sends the control command to the PCN according to the result of the analysis processing, to control the PCN to distribute the information flow in the wireless video conference system;

specifically, the initiator AT receives the signalling flow from the PCN, performs the analysis processing to the signalling in the signalling flow, determines whether the AT which sends the signalling meets the legality and the authority of the conference member information stored in the current wireless video conference system according to the result of the analysis, generates the control command according to the analyzed signalling content when the AT which sends the signalling meets the legality and the authority of the conference member information stored in the current wireless video conference system, and sends the control command to the PCN; the PCN receives the control command and distributes the information flow in the wireless video conference system according to the control command.

Wherein, the analysis processing comprises: analyzing the information of the AT which sends the signalling, the content of the signalling and the like; the control command comprises: the presentation permission command including a receiver list, the audio and/or video distribution command for controlling the PCN to distribute the audio and/or video flow, the data sharing command for controlling the PCN to distribute the data flow, and the like.

Specifically, generating the control command according to the analyzed signalling content comprises: when the analyzed signalling content is a presentation request, generating the presentation permission command which includes the receiver list; when the analyzed signalling content is a data sharing request, generating the data sharing command; and when the analyzed signalling content is a video request, generating the AT number which including the sending video request command, the video distribution command of the AT number which is requested for a video and the like.

Controlling the PCN to distribute the information flow in the wireless video conference system comprises: the PCN receiving and sending the audio and/or video flow of the AT, which sends the presentation request, according to the presentation permission command of the initiator AT; and/or the PCN distributing the data flow according to the data sharing command of the initiator AT; and/or the PCN distributing the video flow according to the video distribution command of the initiator AT; and/or the PCN notifying the RAN to release all the UM interface radio resources according to is the conference ending command of the initiator AT.

Here, the processing for determining whether the AT which sends the signalling has the legality and the authority belongs to prior art, so no further description is needed here.

Several examples are introduced below to describe in detail that the initiator AT receives the signalling and generates the control command so as to control the PCN to distribute the information flow.

For example, when receiving the presentation request command sent by the PCN through the RAN, the initiator AT performs the analysis processing to the presentation request command, wherein the presentation request command comprises: the information of the AT which sends the request, the presentation request and the like; when the AT which sends the request meets the legality and the authority of the conference member information stored in the wireless video conference system, the initiator AT separates, from the stored conference member list, the receiver list of the AT which receives the audio and/or video flow of the AT which sends the presentation request, and sends the presentation permission command including the receiver list to the PCN; after receiving the presentation permission command, the PCN notifies the AT which sends the presentation request to send the audio and/or video flow, and forwards the audio and/or video flow of the AT which sends the presentation request according to the receiver list; the AT which sends the presentation request serves as a presenter to make a presentation; the presenter receives the audio and/or video flow by default, which is distributed by the PCN, of the initiator; if the presenter is the initiator AT, the PCN sends the received audio and/or video flow of the participant AT, which accesses into the wireless audio conference system most rapidly, to the presenter;

for another example, when receiving the data sharing request command sent by the PCN through the RAN, the initiator AT performs the analysis processing to the data sharing request command, wherein the data sharing request command comprises: the information of the AT which sends the request, the data sharing request and the like; when the AT which sends the sharing request command meets the legality and the authority of the conference member information stored in the wireless video conference system, the initiator AT sends the data sharing command which includes the conference member list to the PCN; according to the data sharing command, the PCN notifies the AT which sends the data sharing request command to send the data flow, and distributes the data flow according to the member list of the wireless video conference system;

and for another example, when receiving the video request command sent by the PCN through the RAN, the initiator AT performs the analysis processing to the video sending request command, wherein the video request command comprises: the information of the AT which sends the request, the information of the AT which is requested, the video request and the like; when the AT which sends the video request command meets the legality and the authority of the conference member information stored in the wireless video conference system, the initiator AT sends the video distribution command to the PCN, wherein the video distribution command includes the number of the AT which sends the video request command and the number of the AT which is requested for video; according to the video distribution command, the PCN notifies the AT which is requested for video to send the video flow to the AT which sends the video request command;

in the above examples, the signalling flow and the information flow can also be sent between two PCNs which are far away from each other through an IP network; and the initiator AT intensively controls the PCN to distribute the information flow in the wireless video conference system.

Step 204: at the end of the conference, the initiator AT sends a conference ending command to end the conference;

at the end of the conference, the initiator AT sends the conference ending command, which includes the conference member list, to the PCN through the RAN; the PCN releases all UM interface radio resources according to the conference member list in the conference ending command; the initiator AT clears all stored information of the conference; and the wireless video conference ends.

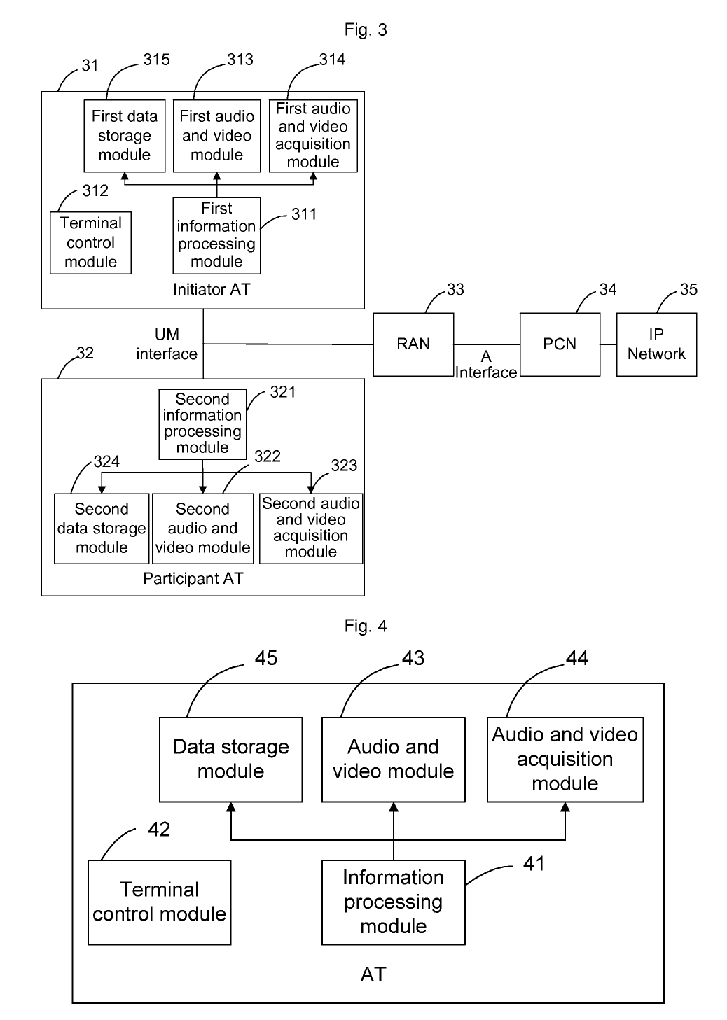

In order to implement the above method, the disclosure also provides the system for implementing the wireless video conference, as shown in FIG. 3, wherein the system comprises: an initiator AT 31, a participant AT 32 and a PCN.

The initiator AT 31 is configured for initiating the establishment of the wireless video conference system, sending and receiving the signalling flow and the information flow, performing analysis processing to the signalling in the received signalling flow, sending the control command, and controlling the PCN 34 to distribute the information flow in the wireless video conference system.

Preferably, the initiator AT 31 comprises: a first information processing module 311, a terminal control module 312 and a first audio and video module 313;

the first information processing module 311 is configured for sending and receiving the signalling flow and the information flow through the RAN 33; specifically, when the wireless video conference system is being established, the first information processing module 311 sends a conference request command to the PCN through the RAN 33, and receives the PPP initialization information sent by the PCN 34 and the IP address assigned by the PCN 34 through the RAN 33; after the successful establishment of the wireless video conference system, the first information processing module 311 sends the presentation request command, the data sharing request command and the video request command, and sends and receives the audio and/or video flow, data flow and the like;

the terminal control module 312 is configured for processing the signalling flow and the information flow which are received through the RAN 33, and sending through the RAN 33 the control command which controls the PCN 34 to distribute the information flow,

specifically, when the wireless video conference system is being established, the terminal control module 312 receives and stores the conference member information sent by the PCN 34 through the RAN 33; after the successful establishment of the wireless video conference system, the terminal control module 312 receives the signalling flow of the participant AT 32 sent by the PCN 34 through the RAN 33 and performs the analysis processing; the signalling flow comprises the presentation request command, the data sharing request command, the audio and/or video request command and the like, and the analysis processing comprises: authenticating the legality and the authority of the analyzed AT which sends the request, and obtaining the is request information in the signalling flow and the like;

and according to the result of the analysis processing, the terminal control module 312 sends the control command to the PCN 34 through the RAN 33; the control command comprises the presentation permission command including the receiver list, the audio and/or video distribution command for controlling the PCN 34 to distribute the audio and/or video flow, the data sharing command for controlling the PCN 34 to distribute the data flow, the conference ending command for controlling to end the conference and the like.

The first audio and video module 313 is configured for converting the audio and/or video flow, distributed by the PCN 34, received by the first information processing module 311 into voice and/or video.

Preferably, the initiator AT 31 further comprises: a first audio and video acquisition module 314 and a first data storage module 315.

The first audio and video acquisition module 314 is configured for acquiring the audio and/or video data of the initiator AT 31 and sending the audio and/or video flow to the PCN 34 under the calling of the first information processing module 311;

specifically, after receiving the audio and/or video distribution command of the initiator AT 31, the PCN 34 notifies the first information processing module 311 of the initiator AT 31 to call the first audio and/or video acquisition module 314 to send the audio and/or video flow to the PCN 34.

The first data storage module 315 is configured for sending the stored data of the initiator AT 31 to the PCN 34 through the RAN 33 under the calling of the first information processing module 311, or storing the data flow, distributed by the PCN 34, received by the first information processing module 311;

specifically, after receiving the data sharing command of the initiator AT, the PCN 34 notifies the first information processing module 311 of the initiator AT to call the first data storage module 315 to send the stored data of the initiator AT to the PCN 34 through the RAN 33, or stores the data flow, distributed by the PCN 34, received by the first information processing module 311.

There may be multiple participant ATs 32 which are configured for attending the is wireless video conference, sending and receiving the signalling flow and the information flow, and processing the received information flow.

The participant AT 32 further comprises a second information processing module 321 and a second audio and video module 322.

The second information processing module 321 is configured for sending and receiving the signalling flow and the information flow through the RAN 33; specifically, when the wireless video conference system is being established, the second information processing module 321 is configured for: receiving the conference invitation information through the RAN 33, and returning a participation or nonparticipation command; receiving the PPP initialization information sent by the PCN 34 through the RAN 33 and the IP address assigned by the PCN 34; after the wireless video conference system is established successfully, sending the presentation request command, the data sharing request command and the video request command, and sending and receiving the audio and/or video flow, the data flow and the like.

The second audio and video module 322 is configured for converting the audio and/or video flow, distributed by the PCN 34, received by the second information processing module 321 into the audio and/or video.

Preferably, the participant AT 32 further comprises a second audio and video acquisition module 323 and a second data storage module 324.

The second audio and video acquisition module 323 is configured for acquiring the audio and/or video data of the participant AT 32, and sending the audio and/or video flow to the PCN 34 under the calling of the second information processing module 321;

specifically, after receiving the audio and/or video distribution command for the participant AT 32, the PCN 34 notifies the second information processing module 321 of the participant AT 32 to call the second audio and video acquisition module 323 to send the audio and/or video flow to the PCN 34.

The second data storage module 324 is configured for sending the stored data of the participant AT 32 to the PCN 34 through the RAN 33 under the calling of the second information processing module 321, or storing the data flow, distributed by the PCN 34, received by the second information processing module 321;

after receiving the data sharing command for the participant AT 32, the PCN 34 notifies the second information processing module 321 of the participant AT 32 to call the second data storage module 324 to send the stored data of the participant AT 32 to the PCN 34 through the RAN 33, or stores the data flow, distributed by the PCN 34, received by the second information processing module 321.

The PCN 34 is configured for receiving and sending the signalling flow and the information flow of the each AT, and distributing the information flow according to the control command of the initiator AT 31;

specifically, when the wireless video conference system is being established, the PCN 34 is configured for: receiving the conference request command of the initiator AT 31 through the RAN 33, authenticating and authorizing the initiator AT 31, establishing the radio resource and performing initialization; and sending the conference invitation according to the conference inviter list in the received conference request command, receiving the participation conference command of the participant AT 32, establishing the radio resource for the participant AT and initializing the participant AT, and sending the conference member list and the IP address information to the initiator AT 31;

after the wireless video conference system is established successfully, the PCN 34 is configured for: receiving the signalling flow sent by the AT through the RAN 33 in the wireless video conference system, sending the signalling flow to the initiator AT 31, receiving the control command of the initiator AT 31, and distributing the information flow among the ATs according to the control command of the initiator AT 31; the distributing includes:

the PCN 34 receiving and sending the audio and/or video flow of the AT which sends the presentation request according to the presentation permission command of the initiator AT 31; the PCN 34 distributing the data flow according to the data sharing command of the initiator AT 31; the PCN 34 distributing the video flow according to the video distribution command of the initiator AT 31; and the PCN 34 releases all UM interface radio resources according to the conference ending command of the initiator AT 31.

The device further comprises:

the RAN 33 configured for transferring the signalling flow and the information flow in the system;

an IP network 35 configured for realizing the connection of a wireless network and a wired network, and sending the signalling flow and the information flow in the wireless video conference between two PCNs which are far away from each other.

It should be understood that in practical application, any AT can serve as the initiator AT or serve as the participant AT.

Based on the above system, the AT of the disclosure, as shown in FIG. 4, comprises: an information processing module 41, a terminal control module 42 and an audio and video module 43.

The information processing module 41 is configured for sending and receiving the signalling flow and the information flow;

specifically, when the AT serves as the initiator AT and the wireless video conference system is being established, the initiator AT sends the conference request command to the PCN through the RAN, receives the PPP initialization information sent by the PCN and the IP address assigned by the PCN through the RAN; after the wireless video conference system is established successfully, the initiator AT sends the presentation request command, the data sharing request command and the video request command, and sends and receives the audio and/or video flow, the data flow and the like; when the AT serves as the participant AT and the wireless video conference system is being established, the participant AT receives the conference invitation information through the RAN, returns participation or nonparticipation command, receives the PPP initialization information sent by the PCN through the RAN and the IP address assigned through the PCN; after the wireless video conference system is established successfully, the participant AT sends the presentation request command, the data sharing request command and the video request command, and sends and receives the audio and/or video flow, the data flow and the like.

The terminal control module 42 is configured for sending through the RAN the control command which controls the PCN to distribute the information flow and processing the signalling flow and the information flow received through the RAN, when is the AT serves as the initiator AT; and the terminal control module 42 does not operate when the AT serves as the participant AT.

Specially, when the AT serves as the initiator AT and the wireless video conference system is being established, the terminal control module 42 receives and stores the conference member information sent by the PCN through the RAN; after the wireless video conference system is established successfully, the terminal control module 42 is configured for receiving the signalling flow of the participant AT, which is sent by the PCN through the RNA, and performing analysis processing, wherein the signalling flow comprises a presentation request command, the data sharing request command, the audio and/or video request command and the like, and the analysis processing comprises: authenticating the legality and the authority of the analyzed AT which sends the request, and obtaining the request information thereof and the like;

According to the result of the analysis processing, the terminal control module 42 sends the control command to the PCN through the RAN. The control command comprises: the presentation permission command including the receiver list, the audio and/or video distribution command for controlling the PCN to distribute the audio and/or video flow, the data sharing command for controlling the PCN to distribute the data flow, the conference ending command for controlling the conference to end and the like.

when the AT serves as the participant AT, the terminal control module 42 does not operate.

The audio and video module 43 is configured for converting the audio and/or video flow, distributed by the PCN, received by the information processing module into the audio and/or video.

Preferably, the AT further comprises: an audio and video acquisition module 44 and a data storage module 45.

The audio and video acquisition module 44 is configured for acquiring the audio and/or video data of the AT and sending the audio and/or video flow to the PCN under the calling of the information processing module 41.

The data storage module 45 is configured for sending the stored data of the AT to the PCN through the RAN, or storing the data flow, distributed by the PCN, received by is the information processing module 41 under the calling of the information processing module 41.

The above is only the preferred embodiment of the disclosure and not intended to limit the scope of protection of the disclosure, and any modifications, equivalent replacements, improvements and the like within the spirit and principle of the disclosure shall include within the scope of protection of the disclosure.

1. A method for implementing a wireless video conference, comprising:
initiating, by an initiator Wireless Access Terminal (AT), a conference request to a Packet Core Network (PCN); performing, by the PCN, a conference invitation according to a conference inviter list included in the conference request, establishing a radio resource and performing initialization for each AT which attends the wireless video conference, and sending information of conference members attending the wireless video conference to the initiator AT for storing to complete an establishment of a wireless video conference system;
receiving, by the PCN, a signalling flow of the AT in the wireless video conference system, after the wireless video conference system is established successfully, and sending the signalling flow to the initiator AT; and
sending, by the initiator AT, a control command to the PCN, according to a signalling in the signalling flow, to control the PCN to distribute an information flow in the wireless video conference system.

2. The method according to claim 1, wherein the conference request comprises: a conference inviter list, a high-priority authority of the initiator AT, and the authority assigned to the AT in the conference inviter list.

3. The method according to claim 1, wherein the step of establishing the radio resource and performing initialization for each AT which attends the wireless video conference comprises:
establishing, by the PCN, the radio resource for the initiator AT, after the PCN receives the conference request, and authenticates and authorizes the initiator AT successfully, sending Point To Point Protocol (PPP) initialization information to the initiator AT, and assigning an Internet Protocol (IP) address to the initiator AT; establishing, by the PCN, a radio resource for an participant AT, after the PCN receives a conference participation command returned by the participant AT, sending the PPP initialization information to the participant AT, and assigning an IP address for the participant AT.

4. The method according to claim 1, wherein the conference member information comprises: a conference member list, a high-priority authority of the initiator AT, an authority of the participant AT attending the wireless video conference, and IP addresses of all ATs.

5. The method according to claim 1, wherein the step of receiving the signalling flow of the AT in the wireless video conference system by the PCN comprises: receiving, by the PCN, the signalling flow of the participant AT and the initiator AT through a Radio Access Network (RAN);
wherein the signalling flow comprises: a presentation request command, a video request command and a data sharing request command.

6. The method according to claim 1, wherein the step of sending the control command to the PCN by the initiator AT according to the signalling in the received signalling flow comprises: receiving, by the initiator AT, the signalling flow from the PCN, performing analysis processing to the signalling in the signalling flow, and sending the is control command to the PCN according to a result of the analysis processing.

7. The method according to claim 1, wherein the step of controlling the PCN to distribute the information flow in the wireless video conference system comprises:
receiving and distributing, by the PCN, an audio and/or video flow of the AT which sends the presentation request, according to a presentation permission command of the initiator AT; and/or,
distributing, by the PCN, a data flow according to the data sharing command of the initiator AT; and/or,
distributing, by the PCN, a video flow according to a video distribution command of the initiator AT; and/or,
releasing, by the PCN, all UM interface radio resources according a conference ending command of the initiator AT.

8. A system for implementing a wireless video conference, comprising:
an initiator AT configured to initiate a conference request, send and receive a signalling flow and a information flow, perform an analysis processing to a signalling in the received signalling flow, and send a control command to control a PCN to distribute an information flow in the wireless video conference system;
a participant AT configured to attend the wireless video conference, send and receive the signalling flow and the information flow, and process the information flow;
a PCN configured to perform conference invitation according to a conference inviter list included in the conference request, establish radio resource and perform initialization for each AT which attends the wireless video conference; and to receive and send a information flow and a information flow of each AT, and distribute the information flow according to the control command of the initiator AT.

9. The system according to claim 8, further comprising:
a RAN configured to transfer the signalling flow and the information flow in the system.

10. The system according to claim 9, wherein the initiator AT comprises:
a first information processing module configured to send and receive the signalling flow and the information flow through the RAN;
a terminal control module configured to process the signalling flow and the information flow received through the RAN, and send a control command for controlling the PCN to distribute the information flow through the RAN;
a first audio and video module configured to convert the audio and/or video flow, distributed by the PCN, received by the first information processing module into voice and/or video;
a first audio and video acquisition module configured to acquire an audio and/or video data of the initiator AT and send an audio and/or video flow to the PCN under the calling of the first information processing module; and
a first data storage module configured to send a stored data of the initiator AT to the PCN through the RAN under the calling of the first information processing module, or store the data flow, distributed by the PCN, received by the first information processing module.

11. The system according to claim 10, wherein the participant AT comprises:
a second information processing module configured to send and receive the signalling flow and the information flow through the RAN; and
a second audio and video module configured to convert the audio and/or video flow, distributed by the PCN, received by the second information processing module into voice and/or video.

12. The system according to claim 10, wherein the participant AT further comprises:
a second audio and video acquisition module configured to acquire the audio and video data of the participant AT, and send the audio and video flow to the PCN under the calling of the second information processing module; and
a second data storage module configured to send the stored data of the participant AT to the PCN through the RAN, or store the data flow, distributed by the PCN, received by the second information processing module under the calling of the second information processing module.

13. An AT, comprising:
an information processing module configured to send and receive a signalling flow and an information flow;
a terminal control module configured to send a control command for controlling the PCN to distribute the information flow, and process the received signalling flow and the information flow when the AT serves as an initiator AT; and
an audio and video module configured to convert an audio and/or video flow, distributed by the PCN, received by the information processing module into the voice and/or video.

14. The AT according to claim 13, further comprising:
an audio and video acquisition module configured to acquire the audio and/or video data of the AT, and send the audio and/or video flow to the PCN under the calling of the information processing module; and
a data storage module configured to send the stored data of the AT to the PCN through a RAN under the calling of the information processing module, or store the data flow, distributed by the PCN, received by the information processing module.
